(19) United States
(12) Patent Application Publication
(10) Pub. No.: US 2020/0181505 A1
(43) Pub. Date: Jun. 11, 2020

(54) Distillation Process Particularly Suitable for Crude Oils that are Difficult to Desalt and for Opportunity Crude Oils, and Associated Devices and Column

(71) Applicants: Bertrand Jean SZYMKOWIAK, Lyon (FR); Albert VELD, Salon De Provence (FR); Constanza MUSSO, Lyon (FR); Ilan Schlomo Simon PARTOUCHE, Villeurbane (FR); Nathan Benjamin PARTOUCHE, Villeurbane (KR); LA HARPE D`OR, Lyon (FR)

(72) Inventors: Bertrand Jean SZYMKOWIAK, Lyon (FR); Albert VELD, Salon De Provence (FR); Alain PARTOUCHE, Villeurbane (FR)

(21) Appl. No.: 16/620,230

(22) PCT Filed: Jun. 7, 2017
(86) PCT No.: PCT/FR2017/051437

§ 371 Date: Dec. 6, 2019

(51) Int. Cl. C10G 7/06; C10G 7/00; B01D 3/32; B01D 3/10; B01D 17/02; B01D 3/14

(52) U.S. Cl. CPC C10G 7/06; C10G 7/00; B01D 3/143; B01D 3/10; B01D 17/0214; B01D 3/32

(57) ABSTRACT

The invention relates to a petroleum product distillation method, comprising a step of distilling said products in a crude atmospheric distillation (CDU) or vacuum distillation (VDU) column (1, 1′), itself comprising a plurality of draw-off trays, including an upper draw-off tray (6, 6′), which is the draw-off tray the closest to the top (3, 3′) of said column (1, 1′), the method further comprising a step of drawing off the distillate (7, 7′) present at said upper draw-off tray (6, 6′), and being characterized in that it also comprises a step of separating said so drawn-off distillate (7, 7′) into, on the one hand, a primary fraction (9) including precipitated chlorinated salts and, on the other hand, a remaining fraction (10).

### TECHNICAL FIELD

The present invention relates to the general field of petroleum refining, and more precisely the steps of atmospheric and vacuum distillation commonly implemented in refineries, as well as the associated devices and column.

The present invention is more particularly related to a petroleum product distillation method comprising a step of distilling said products in a crude atmospheric distillation (CDU) column or a vacuum distillation (VDU) column, wherein the column itself comprises a plurality of draw-off trays, including an upper draw-off tray, which is the closest to the top of said column, the method further comprising a step of drawing off the distillate present at said upper draw-off tray.

The present invention also relates to associated petroleum product distillation device, device for separating a petroleum products distillate, and petroleum product atmospheric distillation (CDU) or vacuum distillation (VDU) column.

### PRIOR ART

The industry of crude oil refining faces a major change of the quality of the crude oils to be processed, which introduces new constraints and problems, not only as regards efficiency and performance, but also in terms of facility integrity and safety.

This evolution of quality of the crude oils to be refined results from the increasing part of so-called “opportunity” oils (also called “opportunity crudes”, “acid crudes”, “high organic acid content crude oil”, “HAC” for “High Acidity Crude”, or “heavy crudes”) that, while being economically attractive, have however physico-chemical characteristics likely to significantly complicate the refining thereof within conventional distillation units.

In particular, these “opportunity crudes” are often heavy, viscous and particularly acid. They also most often contain a high quantity of mineral salts and prove to be particularly difficult to desalt, so that they have, after “desalting” by the commonly used means, residual contents in mineral salts significantly higher than those generally observed for the “conventional” desalted crudes, as well as relatively high contents of various contaminants (additives, transport solvents . . . ).

These physico-chemical features of the opportunity crudes are in particular liable to cause phenomena of potentially serious and rapid damaging of various facilities of the refinery, in particular at the distillation units, for example important phenomena of corrosion causing damages with risks of fire.

This may lead to operating losses (production stop, drop of productivity and profitability of the refining unit) but also and above all to risks of corporeal accident.

Up to now, no solution has proven to be really efficient to respond to the problem exposed hereinabove, which also relates to the difficult-to-desalt petroleums, without affecting the operation efficiency of the distillation units. This problem is all the more complex since the physico-chemical characteristics (viscosity, acidity, quantity and nature of the mineral salts, etc.) of the crudes to be refined are in practice very variable from a crude to another one, according in particular to the portion of opportunity crude that is contained and the provenance (and the conditions of extraction) of these opportunity crudes.

### DISCLOSURE OF THE INVENTION

The objects assigned to the invention hence aim to remedy the different drawbacks mentioned hereinabove and to propose a new petroleum product distillation method capable of efficiently reducing the corrosion over time of the various elements that form the distillation unit and that are connected thereto.

Another object assigned to the invention aims to propose a new distillation method that is simple and not very restricting to implement, and that allows efficiently and simply compensating for the limitations of the desalting efficiencies without harming the capacity of production.

Another object assigned to the invention aims to propose a new distillation method allowing an optimum economic development of the difficult-to-desalt petroleums and of the opportunity crudes, by facilitating the processing thereof in a refinery.

Another object assigned to the invention aims to propose a new, versatile distillation method that may be easily implemented within any distillation unit of a pre-existing refinery or a refinery to be built, while allowing the concerned distillation unit to process a great variety of crudes without thereby being exposed to major risks of damage.

Another object assigned to the invention aims to propose a new distillation method whose implementation within a refinery is easy, rapid and of lesser cost.

Another object assigned to the invention aims to propose a new distillation method allowing maintaining, or even increasing, the productivity of a refinery, whatever the upstream quality, nature or variety of the crude oils to be refined.

Another object assigned to the invention aims to propose a new petroleum product distillation method that is particularly respectful of the environment, and that in particular does not require an additional consumption of water or energy, nor the adding of any additional chemical additive to the petroleum products.

Another object assigned to the invention aims to propose a new distillation method allowing increasing the lifetime of a distillation unit as well as of the elements that are connected to it.

Another object assigned to the invention aims to propose a new distillation method allowing limiting the risk of failure of a distillation column of the distillation unit of a refinery.

Another object assigned to the invention aims to propose a new petroleum product distillation device that is efficient, reliable, whose manufacturing entails no significant additional cost, that includes no complex mechanical elements and that is simple to implement.

Another object assigned to the invention aims to propose a new separation device that, while being of little bulk, simple and practical to implement, allows efficiently reducing the problems of degradation by corrosion of the distillation columns, of the internal parts of these latter and of the associated devices.

Another object assigned to the invention aims to propose a new petroleum product atmospheric distillation or a vacuum distillation column that shows an excellent compromise between cost price and corrosion resistance.

The objects assigned to the invention are achieved by means of a petroleum product distillation method comprising a step of distilling said products in a crude atmospheric distillation (CDU) or a vacuum distillation (VDU) column, wherein the column itself comprises a plurality of draw-off trays, including an upper draw-off tray, which is the draw-off tray the closest to the top of said column, the method further comprising a step of drawing off the distillate present at said upper draw-off tray, and being characterized in that it also comprises a step of separating said so drawn-off distillate into, on the one hand, a primary fraction including precipitated chlorinated salts and, on the other hand, a remaining fraction.

The objects assigned to the invention are also achieved by means of a petroleum product distillation device comprising a crude atmospheric distillation (CDU) or a vacuum distillation (VDU) column, column in which the temperature exceeds the dew point, wherein said column itself comprises a plurality of draw-off trays, including an upper draw-off tray, which is the draw-off tray the closest to the top of said column, and a means for drawing off the distillate present at said upper draw-off tray, characterized in that it also comprises a device for separating said so drawn-off distillate into, on the one hand, a primary fraction including precipitated chlorinated salts and, on the other hand, a remaining fraction.

The objects assigned to the invention are also achieved by means of a device for separating by gravity a petroleum product distillate drawn off from a crude atmospheric distillation (CDU) or a vacuum distillation (VDU) column into, on the one hand, a primary fraction including precipitated chlorinated salts and, on the other hand, a remaining fraction, the separation device comprising:
a gravity separator intended to collect said distillate, and
a collector placed substantially under said separator and in fluidic communication with the latter, said collector being intended to collect said primary fraction by gravity.

The objects assigned to the invention are also achieved by means of a petroleum product atmospheric distillation (CDU) or a vacuum distillation (VDU) column comprising a plurality of draw-off trays, including an upper draw-off tray, which is the draw-off tray the closest to the top of said column, and at least one lower draw-off tray positioned at an altitude lower than that of said upper draw-off tray, characterized in that said upper draw-off tray is made of a first material resisting to corrosion, in particular the corrosion by precipitated chlorinated salts, said first material being chosen among a group comprising titanium and the superalloys whose main components are, on the one hand, nickel, and on the other hand, chromium and/or copper.

### BRIEF DESCRIPTION OF THE DRAWINGS

Other features and advantages of the invention will appear and be revealed in more detail by reading the following description, with reference to the appended drawings, given only by way of illustrative and non-limitative examples, in which:

FIG. 1 is a diagram of a petroleum product distillation device according to a first embodiment of the invention, in which the distillation column is a crude atmospheric distillation (CDU) column.

FIG. 2 is a diagram of a petroleum product distillation device according to a second embodiment of the invention, in which the distillation column is a vacuum distillation (VDU) column.

FIG. 3 illustrates, in a schematic front sectional view, a device for separating a petroleum product distillate according to the invention.

FIG. 4 illustrates, in a schematic front sectional view, the separation device of FIG. 3, herein equipped, in particular, with a collector and a recovery tank.

FIG. 5 is a diagram of a petroleum product distillation device according to a third embodiment of the invention, in which the distillation column is a vacuum distillation (VDU) column.

### BEST WAY OF IMPLEMENTING THE INVENTION

The invention relates, according a first aspect illustrated in the figures, to a petroleum product distillation method.

Said petroleum products are formed, for example, of crude, possibly desalted, i.e. passed through a desalting unit (for example with washing waters) known in itself. Said petroleum products formed of optionally desalted crude are preferentially intended to undergo a step of atmospheric pressure distillation in an atmospheric distillation column. According to another example, said petroleum products have already undergone a step of distillation at atmospheric pressure, and are intended to undergo a step of vacuum distillation in a vacuum distillation column. In other words, said petroleum products object of the method according to the invention are preferably the little or non-refined hydrocarbons that are found at the beginning of the process in a refinery.

The method according to the invention is a method of distillation, i.e. of fractionation (or separation), of the petroleum products, according to their physico-chemical properties, and more particularly according to their boiling point, into different fractions having different physico-chemical characteristics.

More precisely, the method comprises a step of distillation of said petroleum products in a distillation column 1, 1′. In other words, the method comprises a first step of distillation in a distillation column 1, 1′, said step being known as such. At the end of this step, said petroleum products are separated into different fractions according to their physico-chemical properties, one of said different fractions being a gas fraction 2, 2′ evacuated from said column via the top 3, 3′ of said column 1, 1′, several of them being intermediate fractions (which are hence distillates) collected along said column 1, 1′, and a last one being residual matter (not shown) at the bottom of said column 1,1′.

Advantageously, said step of distillation of said petroleum products is continuous, i.e. it is implemented over a significant period of time (several weeks to several years) without interruption, except for occasional maintenance operations.

According to the invention, said column is a crude atmospheric distillation (CDU) column 1 or a vacuum distillation (VDU) column 1′.

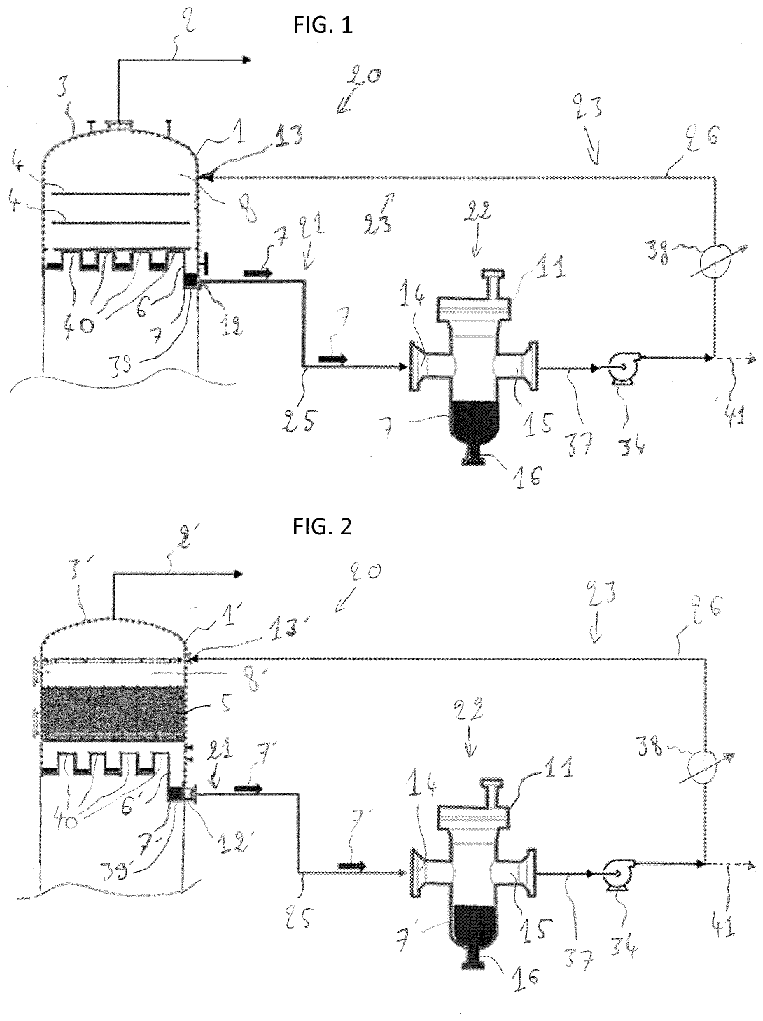

Said atmospheric distillation column 1, or CDU for “Crude (or Crude oil) Distillation Unit”, is a part of the most upstream equipment in an industrial refinery, and is, as known, designed to distillate petroleum products comprising optionally desalted crude during a step commonly called “atmospheric distillation”. Said atmospheric distillation step is generally the first major step of the petroleum refining process. An example of atmospheric distillation (CDU) column 1 according to the invention is partially illustrated in FIG. 1 (only an upper part of the column has been shown).

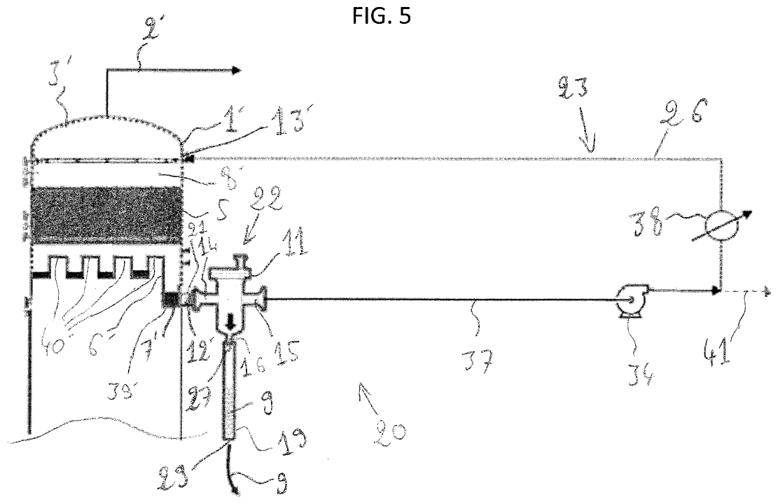

Said vacuum distillation column 1′, or VDU for “Vacuum Distillation Unit”, or also reduced pressure distillation column, is also a part of the most upstream equipment of an industrial refinery, and is, as known, designed to distillate petroleum products, and more particularly petroleum products coming directly (i.e. with no intermediate chemical processing, but generally via a heating furnace) from an atmospheric distillation column 1, during an important step generally called “vacuum distillation” (or reduced-pressure distillation). Examples of vacuum distillation (VDU) columns 1′ according to the invention are particularly illustrated in FIGS. 2 and 5 (only an upper part of the column has been shown).

The distillation column according to the invention may hence be an atmospheric distillation column 1 or a vacuum distillation column 1′ as exposed hereinabove. Except otherwise stated, the term “column” or the expression “distillation column” will denote indifferently an atmospheric distillation column 1 or a vacuum distillation column 1′, the invention being intended to apply indifferently to either one. Advantageously, a refinery may include at least two distillation devices implementing the distillation method according to the invention, one of which including an atmospheric distillation column 1, and the other one including a vacuum distillation column 1′, said vacuum distillation column 1′ being for example downstream (according to the direction of circulation of the petroleum products in the refinery) from said atmospheric distillation column 1. The expression “distillation unit” preferably denotes, in particular in a refinery, all the devices allowing the atmospheric distillation and the vacuum distillation as mentioned hereinabove.

Preferably, during said distillation step, the temperature within said column 1, 1′ exceeds the dew point, or water condensing temperature. In other words, during the implementation of the distillation step, in normal operation mode of said column 1, 1′, the temperature within said column 1, 1′ is preferably always higher than the lowest temperature to which a mass of water vapour may be subjected inside said column 1, 1′, without a formation of liquid water occurs by saturation inside said column 1, 1′, and that for given conditions of pressure and humidity.

According to the invention, said column 1, 1′ itself comprises a plurality of draw-off trays. Said draw-off trays, preferably positioned, in a stepped manner, at different altitudes inside said column 1, 1′, are known as such. They each advantageously allow collecting one of said intermediate fractions of petroleum (or petroleum cuts) separated from each other by the distillation step, for the drawing off thereof from said column 1, 1′. Said trays are preferably each generally plate-shaped, arranged substantially perpendicular to the direction of longitudinal extent of said column 1, 1′ (i.e. the vertical direction), said tray being advantageously provided, as illustrated in FIGS. 1, 2 and 5, with at least one retention area 39 allowing collecting said considered intermediate fraction, collected along said column 1, 1′, during said distillation step. Preferably, and as illustrated in FIGS. 1, 2 and 5, each draw-off tray also comprises areas 40, 40′ for the passage of the gas from the bottom of the column 1, 1′ to the top of the column 1, 1′, during said distillation step, said passage areas 40, 40′ being for example in the form of chimneys provided with deflectors.

Advantageously, and as shown in FIG. 1, said column 1, 1′ comprises one or several valve or perforated trays 4, known as such and preferentially positioned at different altitudes inside said column 1, 1′, perpendicular to its longitudinal extent direction. Said valve or perforated trays 4 allow collecting a portion of a considered intermediate distillate and pouring it on a draw-off tray positioned below them.

Advantageously, and as shown in FIGS. 2 and 5, said column 1, 1′, and more particularly when it forms a vacuum distillation (VDU) column 1′, comprises a “packing” 5 preferably formed of one or several grids or an assembly of corrugated plates mounted vertically back-to-back. Said packing 5 essentially advantageously fulfils the same function as said valve or perforated trays 4.

According to the invention, and as shown in FIGS. 1, 2 and 5, said plurality of draw-off trays comprises an upper draw-off tray 6, 6′, which is the draw-off tray the closest to the top 3, 3′ of said column 1, 1′. In other words, the upper draw-off tray 6, 6′ is the draw-off tray located, inside said column 1, 1′, at an altitude that is higher than that of the other draw-off trays.

According to the invention, the method further comprises a step of drawing off the distillate 7, 7′ present at said upper draw-off tray 6, 6′. In other words, during said draw-off step, the distillate 7, 7′ (or intermediate fraction that is liquid at the highest possible altitude in said column 1, 1′) that is accumulated by the upper draw-off tray 6, 6′ during said distillation step, is removed from said column 1, 1′ and from said tray 6, 6′, preferably via an outlet tap 12, 12′ arranged on said column 1, 1′ at said upper draw-off tray 6, 6′, as illustrated in FIGS. 1, 2 and 5.

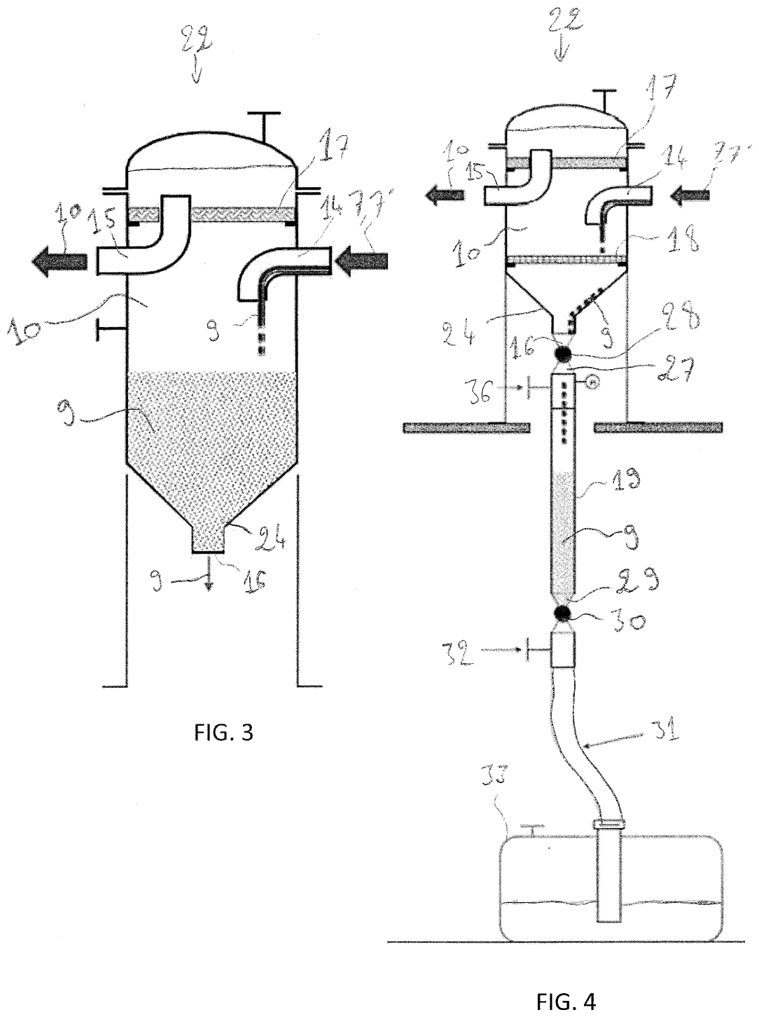

According to the invention and as shown in FIGS. 3 and 4, the method also comprises a step of separating said so drawn-off distillate 7, 7′ into, on the one hand, a primary fraction 9 including precipitated chlorinated salts, and on the other hand, a remaining fraction 10. In other words, said distillate 7, 7′ drawn off at said upper draw-off tray 6, 6′ is fractioned into two different fractions, preferably fractions of different densities, said separation step being preferably a gravity separation step. Advantageously, said remaining fraction 10 is mainly composed of hydrocarbons present in said petroleum products previously distilled and collected by said upper draw-off tray 6, 6′, i.e. in said distillate 7, 7′.

Preferably, said precipitated chlorinated salts are chloride salts, for example ammonium or amine chloride salts.

Advantageously, said primary fraction 9 is predominantly formed in weight of said precipitated chlorinated salts, preferably at more than 80% by weight.

Preferably, at least one portion, preferably the majority, or even the totality, of said precipitated chlorinated salts, is hydrated. In other words, at least some of said precipitated chlorinated salts are advantageously hydrated, i.e. they attract and hold molecules of water present in the column. More preferably, said precipitated chlorinated salts are hydrated by non-deliquescent hygroscopicity, i.e. they attract molecules of water without being dissolved therein. The primary fraction is hence advantageously predominantly formed by precipitated chlorinated salts at least partially hydrated by non-deliquescent hygroscopicity. Within the framework of the invention, it has been discovered that chlorinated salts tended to be formed inside said distillation column 1, 1′ during said distillation step. Said chlorinated salts are formed by precipitation under certain physico-chemical conditions, in particular of temperature (other operation factors may also have an influence, as for example the operation pressure, the reflux temperatures, the quantity of stripping steam, etc.). For example, in an atmospheric distillation column 1, the risk of precipitation of said chlorinated salts may exist from, for example, about 130° C. and below.

Although it is difficult to explain precisely the corrosion phenomena, and in particular the corrosion phenomena of a distillation unit of a refinery caused by the petroleum products in course of refining, it has been highlighted, within the framework of the invention, that the precipitated chlorinated salts had a high influence on the corrosion of the different elements forming the distillation unit.

It has been discovered that, if certain of said precipitated chlorinated salts, once formed in said column 1, 1′, are not corrosive as such, they however have a highly hygroscopic nature that allow them to attract the water vapour present in the column. In other words, at least one portion of said chlorinated salts will, in a rather unexpected manner, be hydrated even when there is no water in liquid state in said distillation column 1, 1′, because the temperature is higher than the dew point or at the very least close to the latter, which limits, or even forbids, the formation of liquid water in said column 1, 1′ (in particular by condensation). Said water vapour comes, for example, from the desalting water or is injected, in a manner known as such, in the bottom of said column 1, 1′ during said distillation step.

The hydration leads in particular to the hydrolysis of at least one portion of said precipitated chlorinated salts, hence making them extremely corrosive for most of the materials. Within the framework of the invention, it has indeed been highlighted that the hydrochloric acid HCl present in the column 1, 1′, for example released during the hydrolysis of salts remaining in the crude (even after desalting), in particular salts such as CaCl₂ and MgCl₂, will show its corrosive power within said precipitated chlorinated salts (in particular hydrated), and that even in the absence of liquid water. Said chlorinated salts, once formed by precipitation in said distillation column 1, 1′, and at least partially hydrated due to their hygroscopic nature, are hence transformed into deposits of extremely corrosive viscous chlorinated salts that flow downward by gravity effect, until arriving on one of said draw-off trays, in particular said upper draw-off tray 6, 6′.

These precipitated chlorinated salts, made viscous and corrosive by hygroscopic hydration and hydrochloric acid release, corrode most of the materials with which they are in contact during their descent in said column 1, 1′, in particular, they degrade or even pierce intermediate distillate draw-off trays and draw-off lines, harming the good operation of the distillation unit of the refinery. The hydrated and viscous chlorinated salts have preferably a density higher than that of the hydrocarbons contained in said petroleum products. For example, said primary fraction 9 and/or said precipitated chlorinated salts contained therein show(s) a volumetric mass density higher than 1, for example about 1.3 g/cm³, whereas said remaining fraction 10 and/or said hydrocarbons contained therein show(s) a volumetric mass density of about 0.85 g/cm³.

It is advantageous to maintain the temperature inside said distillation column 1, 1′ above the dew point, and that in order to avoid that water drops containing acid, and in particular hydrochloric acid HCl, condense in said column 1, 1′, and in particular at the column head 8, 8′ (i.e. in the area located between said upper draw-off tray 6, 6′ and said top 3, 3′ of said column 1, 1′) and significantly degrade the walls of said column head 8, 8′ by corrosive acid attack.

Moreover, the use of a temperature higher than the dew point allows keeping a total control of the process by avoiding the formation of liquid water and hence the dissolution of said precipitated chlorinated salts in the liquid water.

Hence, by holding the temperature inside said column 1, 1′, and in particular at the column head 8, 8′, above the dew point but low enough to allow the formation of precipitates of chlorinated salts, the formation of said precipitated chlorinated salts is favoured while avoiding the formation of water at liquid state (in particular by condensation).

It has been discovered that it was particularly beneficial to remove said primary fraction 9 (and hence the precipitated chlorinated salts contained therein) at the upper draw-off tray 6, 6′ of said column 1, 1′, so as to avoid a propagation of said primary fraction 9 in the equipment located downstream from or below the upper draw-off tray 6, 6′, propagation that would expose this equipment (lower trays, pipes, etc.) to a high risk of degradation by corrosion.

Advantageously, said precipitated chlorinated salts are predominantly precipitated ammonium and/or amine salts, preferably at more than 80% by weight. The ammonia and/or amines present in these salts come for example from nitrogenous species present in said petroleum products (coming in particular from the thermal decomposition of nitrogenous compounds contained in the petroleum products during a heating step preliminary or belonging to any distillation step) or in anticorrosion products injected into the facility.

Still more advantageously, said ammonium salts are ammonium chloride salts. Within the framework of the invention, it has indeed been discovered that the combination of ammonia (NH₃) with hydrochloric acid (HCl) present in the upper section of the column, may in particular lead to the precipitation of ammonium chloride salts (NH₄Cl), this precipitation being in particular function of the respective concentrations of the compounds and of the operating temperature of the head 8, 8′ of said column 1, 1′. Said ammonium chloride salts (NH₄Cl) are moreover particularly hygroscopic, and are hydrated even in the absence of liquid water in said column 1, 1′, hence forming a viscous substance, for example semi-solid, extremely corrosive.

Preferably, and as illustrated in the figures, said separation step is performed by means of a gravity separator 11. In other words, said distillate 7, 7′ is advantageously divided into said primary fraction 9 and said remaining fraction 10 by acting on the difference of density between said primary 9 and remaining 10 fractions, said primary fraction being advantageously denser. In still other words, said primary 9 and remaining 10 fractions are advantageously separated from each other by gravity settling in a suitable container (the separator 11).

More preferably, and as illustrated in the figures, said separator 11 is a container designed to contain said primary 9 and remaining 10 fractions, and in particular designed to contain said precipitated chlorinated salts, more particularly precipitated and hydrated ammonium chloride salts.

Advantageously, the distillation method also comprises a step of reintroducing said remaining fraction 10 into said column 1, 1′. In other words, the distillate 7, 7′ drawn off from said column 1, 1′ at said upper draw-off tray 6, 6′ is advantageously divided into a primary fraction 9 and a remaining fraction 10, the latter being hereinafter injected, for example after thermal exchange, into said distillation column 1, 1′. In still other words, said distillate 7, 7′ is advantageously drawn off from said column 1, 1′, then partially reintroduced into the latter, in the form of said remaining fraction 10, said primary fraction 9 being itself not reintroduced into said column 1, 1′.

Preferably, and as illustrated in FIGS. 1, 2 and 5, the reintroduction of said remaining fraction 10 into said column 1, 1′ is made via an inlet tap 13, 13′ in said column 1, 1′ at an altitude higher than that of said upper draw-off tray 6, 6′.

As an alternative, and as illustrated in FIG. 1, the distillation method comprises a step of definitive discharge of said remaining fraction 10, during which said remaining fraction 10, after having been extracted from said separator 1 during said extraction step, is evacuated towards another unit (processing, storage or other) of the refinery, for example via a definitive discharge line 41. Optionally, the distillation method comprises a definitive discharge step and a concomitant reintroduction step, the remaining fraction being separated into two portions, one of which being reinjected into said column 1, 1′, the other being evacuated elsewhere than into said column 1, 1′ via the definitive discharge line 41.

Advantageously, and as illustrated in the figures, the distillation method of the invention does not include the step of adding water to said distillate 7, 7′, to said remaining fraction 10, or to said primary fraction 9 when the latter is inside said separator 11. The distillation method has hence the advantage that it does not need adding additional water into the species drawn off from said column 1, 1′ (in particular the distillate 7, 7′), the species reintroduced into said column 1, 1′ (in particular the remaining fraction 10), or the species present in said separator 11 (in particular the distillate 7, 7′, the remaining 10 and primary 9 fraction). Still more advantageously, the distillation method comprises no step of desalting by water washing the hydrocarbons contained in said remaining fraction 10.

Preferentially, and as shown in the figures, during said separation step, said primary fraction 9, which is advantageously denser than said remaining fraction 10, is separated by gravity from the remaining fraction 10. In other words, said primary fraction 9, advantageously mainly composed of said precipitated chlorinated salts, is heavier, for a same volume, than said remaining fraction 10, advantageously mainly composed of hydrocarbons, said primary fraction 9 hence going to constitute the lower fraction inside said gravity separator 11, said remaining fraction 10 then constituting the upper fraction inside said separator 11, the two primary and remaining fractions forming for example liquid or semi-liquid phases that are preferably non-miscible. The primary 9 and remaining 10 fractions are hence stepped within the separator 11, with the primary fraction 9 arranged under the remaining fraction 10. In still other words, during said separation step, said primary fraction 9 is advantageously settled in the bottom of said separator 11, whereas said remaining fraction 10, less dense than said primary fraction 9, will “float” on the latter, i.e. migrate and stagnate above the latter.

Advantageously, and as shown in the figures, the distillation method also comprises:
previously to said separation step, a step of introducing said distillate 7, 7′ into said separator 11 via an inlet 14 of said separator 11, and
subsequently to said separation step, an extraction step during which said remaining fraction 10 is extracted at least partially from said separator 11 via a first outlet 15 of said separator 11.

In other words, said distillate 7, 7′ advantageously arrives into said separator 11 via an inlet 14 or an orifice during said introduction step, then is preferably separated in said separator 11 into said primary 9 and remaining 10 fractions during said separation step, said remaining fraction 10 being then removed at least partially from said separator 11 via a first outlet 15 (i.e. advantageously a first outlet orifice formed in said separator 11) during said extraction step.

Advantageously, and as shown in the figures, the distillation method comprises, subsequently to said separation step, a first step of evacuating by gravity said primary fraction 9 from said separator 11 via a second outlet 16 of said separator 11. In other words, once said primary fraction 9 advantageously settled in the bottom of said separator 11 during said separation step, said primary fraction 9 being preferably removed from said separator 11 via a second outlet 16 (i.e. advantageously a second outlet orifice formed in said separator 11).

Preferably, and as shown in the figures, said inlet 14 and said first 15 and second 16 outlets of said separator 11 are all distinct from each other. In other words, said separator 11 has advantageously at least three distinct fluid passage orifices, two for the exit and one for the entry.

Advantageously, and as shown in FIGS. 3 and 4, after said separation step, said remaining fraction 10 undergoes a filtration step inside said separator 11. Said step of filtering said remaining fraction 10 allows in particular filtering, i.e. retaining in said separator 11, potential particles or foreign bodies, that would be accidentally present in said column 1, 1′ and transported with said distillate 7, 7′.

For that purpose, said separator 11 advantageously further comprises a first means 17 for filtering said remaining fraction 10, designed to filter said remaining fraction 10 before the extraction thereof from said separator 11. Advantageously, and as shown in FIGS. 3 and 4, said first filtration means 17 is a grid.

Advantageously, and as shown in FIG. 4, after said introduction step, said primary fraction 9 undergoes a filtration step inside said separator 11. Said step of filtering said primary fraction 9 allows in particular filtering, i.e. retaining in said separator 11, potential particles or foreign bodies that would be accidentally present in said column 1, 1′.

For that purpose, said separator 11 preferably further comprises a second means 18 for filtering said primary fraction 9, designed to filter said primary fraction 9 before the evacuation thereof from said separator 11. Advantageously, and as shown in FIG. 4, said second filtration means 18 is a grid or a grating.

Preferably, and as shown in FIGS. 4 and 5, during said first evacuation step, said primary fraction 9 is evacuated by gravity in a collector 19 placed substantially under said separator 11 and in fluidic communication with the latter. The collector 19 is preferably a container designed to collect in an extended manner said primary fraction 9 (and hence the precipitated chlorinated salts, in particular hydrated and particularly corrosive contained therein), under said separator 11, advantageously in the immediate proximity of the latter, said collector being connected to said separator 11 so that said primary fraction 9 (which is formed for example by a set of viscous salts) can be evacuated by gravity, i.e. slide down by gravity effect, from said separator 11 into said collector 19.

Preferably, and as shown in FIGS. 4 and 5, the distillation method further comprises a second step of evacuating by gravity said primary fraction 9 from said collector 19. In other words, said primary fraction 9, once advantageously evacuated by gravity from said separator 11 during said first evacuation step, is preferably also evacuated by gravity from said collector 19, and that in order to be able to recover said primary fraction 9, for example in a recovery tank 33, as will be shown hereinafter.

Preferably, and as shown in FIG. 4, the distillation method further comprises an isolation step, in which said collector 19 is isolated from said separator 11. In other words, said isolation step is advantageously a step in which said primary fraction 9 is prevented from being evacuated from said separator 11 into said collector 19, and that, in particular, in order to be able to drain said primary fraction 9 from the collector 19 during said second evacuation step.

Preferably, and as shown in FIG. 4, the distillation method further comprises a step of increasing the pressure inside said collector 19. Said pressure increasing step allows in particular facilitating said second step of evacuating by gravity said primary fraction 9 from said collector 19. Said pressure increasing step allows in other words advantageously favouring the gravity action by “pushing” said primary fraction 9 from said collector 19, in order to allow a faster evacuation of said primary fraction 9 from said collector 19. In still other words, said pressure increasing step advantageously allows more efficiently draining said primary fraction 9 from said collector 19.

Advantageously, said pressure increasing step is made by injection of vapour into said collector 19, for example by injection of water steam or of a neutral gas.

Preferentially, the distillation method comprises at least one step of measuring (preferably automatically) the level of said primary fraction 9 inside said separator 11 and/or said collector 19. This step advantageously allows knowing when implementing or stopping said first and second evacuation steps as well as said isolation step, or in other words knowing when said separator 11 and/or said collector 19 contain too much primary fraction 9 and must be drained or not.

Preferably, at least said draw-off, separation and extraction steps are performed in a continuous cycle, in this order. In other words, said distillate 7, 7′ and said remaining fraction 10 advantageously circulate in a continuous cycle in which said draw-off (of the distillate 7, 7′), separation and extraction steps follow each other. Advantageously, the almost-totality of the hydrocarbons contained in the distillate 7, 7′ are hence extracted from the separator 11 in the remaining fraction 10, continuously, without interruption for example of the distillation step, of the distillation unit in general, or of the refinery. This is particularly advantageous because the petroleum refining is generally itself a continuous process.

Still more preferably, said continuous cycle also comprises said reintroduction step, which is advantageously implemented after said extraction step.

Advantageously, the distillation method comprises, before the reintroduction step, a step of cooling said remaining fraction 10. Such a way to proceed allows in particular controlling the temperature inside said column 1, 1′ by lowering it in a controlled manner thanks to said cooling step.

The invention also relates as such, according to a second aspect, a petroleum product distillation device 20, preferably designed to implement the above-described petroleum product distillation method. The above-mentioned description relating to the distillation method hence also applies to the distillation device 20 according to the invention.

According to the invention, and as illustrated in FIGS. 1, 2 and 5, the petroleum product distillation device 20 comprises a crude atmospheric distillation (CDU) column 1 or a vacuum distillation (VDU) column 1′, as described hereinabove. In particular, said column 1, 1′ is designed so as to be able to implement said distillation step.

Advantageously, the distillation device 20 comprises a crude atmospheric distillation (CDU) column 1 and a vacuum distillation (VDU) column 1′ as described hereinabove.

Within said column 1, 1′ of the distillation device 20, the temperature exceeds the dew point, i.e. said distillation column 1, 1′ is designed so that the inner temperature thereof is higher than the temperature at which the water will be able to condensate in said column 1, 1′.

According to the invention, and as illustrated in FIGS. 1, 2 and 5, said column 1, 1′ itself comprises a plurality of draw-off trays, including an upper draw-off tray 6, 6′, which is the draw-off tray the closest to the top 3, 3′ of said column 1, 1′, as described hereinabove.

According to the invention, and as illustrated in FIGS. 1, 2 and 5, the distillation device 20 also comprises a means 21 for drawing off the distillate 7, 7′ present at said upper draw-off tray 6, 6′. Said draw-off means 21 is advantageously designed to implement said draw-off step.

Preferably, and as illustrated in FIGS. 1, 2 and 5, said draw-off means 21 comprises an outlet tap 12, 12′ arranged on said column 1, 1′ at said upper draw-off tray 6, 6′, in order to draw off said distillate 7, 7′ from said column 1, 1′.

Advantageously, and as illustrated in FIGS. 1 and 2, said draw off means 21 also comprises a draw-off line 25, which comprises for example a pipe, and which is fluidically connected to said outlet tap 12, 12′ and hence to said column 1, 1′.

According to the invention, and as shown in the figures, the distillation device 20 also comprises a device 22 for separating said so drawn-off distillate 7, 7′ into, on the one hand, a primary fraction 9 including precipitated chlorinated salts and, on the other hand, a remaining fraction 10. Said separation device 22 is advantageously a gravity separation device 22 and is preferably designed to implement said separation step.

Advantageously, and as shown in the figures, said separation device 22 comprises a gravity separator 11 intended to collect said distillate 7, 7′. Said separator 11 is advantageously designed to implement said separation step.

Preferably, and as shown in the figures, said separator 11 comprises:
in inlet 14 intended to introduce said distillate 7, 7′ into said separator 11,
a first outlet 15 intended to extract said remaining fraction 10 from said separator 11, and
a second outlet 16 intended to evacuate said primary fraction 9 from said separator 11, and which is distinct from said first outlet 15.

Preferably, and as shown in FIGS. 1 and 2, said draw-off line 25 fluidically connects said separator 11 to said column 1, 1′ via said inlet 14 of said separator 11 and said outlet tap 12, 12′ of said column 1, 1′, respectively.

As an alternative, and as illustrated in FIG. 5, said inlet 14 of said separator 11 opens directly in said outlet tap 12, 12′. Such a configuration allows doing without the draw-off line between said column 1, 1′ and said separator 11, and hence reducing the cost of manufacturing of said distillation device 20. Such a configuration also allows positioning said separator 11, on the one hand, substantially at the same altitude than that of said upper draw-off tray or slightly below, and on the other hand, substantially near said column 1, 1′.

Advantageously, and as shown in the figures, said second outlet 16 is located at an altitude lower than that of said first outlet 15 and of said inlet 14. In other words, said remaining fraction 10 advantageously exits from said separator 11 at a height higher than that at which said primary fraction 9 exits, and at which said distillate 7, 7′ enters. Such a configuration makes the gravity separation of said primary 9 and remaining 10 fractions more efficient, said primary fraction 9 being denser than said remaining fraction 10 and tending to flow towards the bottom 24 of said separator 11.

Preferably, said inlet 14 is located at the same altitude as that of said first outlet 15.

Advantageously, said inlet 14 and said first outlet 15 are coaxial to each other. In other words, said inlet 14 and first outlet 15 each have advantageously a central axis, preferably horizontal, and are preferably arranged opposite each other at the same height, said two axes being aligned and merged with each other. Such a configuration allows easily integrating the separator 11 to a pre-existing flow line of the facility, for example said draw-off line 25 or a fluidic connection line 37 (described hereinafter), or between these two lines.

As shown in the figures, said inlet 14 and said first 15 and second 16 outlets are preferably formed by orifices distinct from each other, formed in said separator 11 (itself advantageously formed in a container). Indifferently, as also illustrated in FIGS. 3 and 4, said inlet 14 and said first 15 and second 16 outlets are orifices formed in respective distinct pipes, said respective pipes entering said separator 11 and being designed to introduce said distillate 7, 7′ into said separator 11, evacuate said primary fraction 9, and extract said fraction 10 from said separator 11.

Preferably, and as shown in FIGS. 3 and 4, said separator 11 comprises a bottom 24 having the shape of a hopper or a funnel, whose smallest opening is directed downward and forms said second outlet 16. Such a configuration of the separator 11 allows better “concentrating” said primary fraction 9 in a localized and confined area and favouring the flow of said precipitated chlorinated salts to drain these latter from said separator 11 by gravity, the bottom 24 of the separator 11 advantageously forming, thanks to its preferably truncated shape, a blank angle of about 30° for example. Said precipitated chlorinated salts are for example semi-solid, i.e. they show a behaviour of semi-solid flow, as a viscous deposit mainly composed of solid material (herein, precipitated chlorinated salts) but able to flow by gravity, the above-mentioned bank shape favouring this flow and allowing a full draining.

Advantageously, as illustrated in FIGS. 4 and 5, said separation device 22 further comprises a collector 19 placed substantially under said separator 11 and in fluidic communication with the latter, said collector 19 being intended to collect said primary fraction 9 by gravity. Preferably, said collector 19 is designed to implement said second step of evacuating said primary fraction 9 from said collector 19.

Preferably, as illustrated in FIGS. 4 and 5, said collector 19 further comprises an inlet opening 27 for the entry of said primary fraction 9 that fluidically corresponds with said second outlet 16. In other words, said collector 19 advantageously comprises an orifice (said inlet opening 27) communicating with another orifice (said second outlet 16) of said separator 11, in order to allow said primary fraction 9 to be evacuated by gravity from said separator 11 into said collector 19 by passing through said orifices (in practice, through said second outlet 16, then through said inlet opening 27). Advantageously, said primary fraction 9 passes through said inlet opening 27 to enter said collector 19 during said first evacuation step.

Advantageously, and as illustrated in FIG. 4, the distillation device 20 also comprises a first means 28 for the reversible blocking of said inlet opening 27 and/or of said second outlet 16. In other words, said first blocking means 28 is advantageously designed to completely cut the fluidic communication between said separator 11 and said collector 19, and that temporarily. Preferably, said first blocking means 28 is designed to implement said isolation step.

Advantageously, said first blocking means 28 is a valve, for example an isolation valve.

Preferably, as illustrated in FIG. 4, said collector 19 further comprises an outlet opening 29 for the exit of said primary fraction 9, located at an altitude lower than that of said inlet opening 27, and second means 30 for the reversible blocking of said outlet opening 29. In other words, said collector 19 advantageously comprises an orifice (said outlet opening 29) for the gravity evacuation of said primary fraction 9 from said collector 19, said orifice being able to be entirely blocked by said second blocking means 30, and located lower than said inlet opening 29. Advantageously, said primary fraction 9 passes through said outlet opening 29 to exit from said collector 19 during said second evacuation step.

Advantageously, said second blocking means 30 is a valve, for example an isolation valve.

Advantageously, said collector 19 comprises at least one level detector designed to measure one or several level(s) of primary fraction 9 contained in said collector 19. Said level detector comprises for example one (or several) level sensor, such as a solid level sensor or a density sensor. For example, said level detector is designed to measure a plurality of levels of primary fraction 9 contained in said collector 19, for example at least four levels. Optionally, said separator 11 further comprises a security level detector, for example a security level sensor, designed to measure at least one security level of primary fraction 9 quantity contained in said separator 11. Hence, it is for example particularly advantageous to close said first blocking means 28 when said security level detector of said separator 11 detects that said primary fraction 9 in said separator 11 is lower than the safety level, and the reverse. It is also for example advantageous to close said first blocking means 28 when said level detector of said collector 19 detects that said primary fraction 9 in said collector 19 is higher than a certain level, and the reverse. Finally, it is particularly advantageous for example to open said second blocking means 30 when said level detector of said collector 19 detects that said primary fraction 9 in said collector is higher than a certain level, and the reverse.

Still more advantageously, said sensors and said first 28 and second 30 blocking means are associated with a means for the automated regulation of the level of said primary fraction 9 in said separator 11 and/or said collector.

Preferably, and as shown in FIG. 4, said collector 19 is of substantially elongated shape, with a height higher than a width and a thickness, and is preferably of cylindrical shape. Said collector 19 is preferably intended to be positioned vertically, so that the level of primary fraction 9 contained therein can be read, for example thanks to said level detector.

Preferably, as illustrated in FIG. 4, said outlet opening 29 is fluidically connected to a means 31 for removing said primary fraction 9 by gravity, for example a flexible pipe 31, and to a means 32 for injecting a fluid (in particular, water) into said removal means 31 to neutralize and/or dissolve the precipitated chlorinated salts contained in said primary fraction 9. Such a configuration advantageously allows using only a minimum of fluid to neutralize said generally very acid precipitated chlorinated salts contained in said primary phase 9, without needing washing the hydrocarbons coming from the column 1, 1′ (which are for example predominantly contained in said remaining fraction 10), in particular for desalting it, for example with a massive injection of water.

Advantageously, as illustrated in FIG. 4, said gravity removal means 31 is intended to pour said primary fraction 9 in a recovery tank 33 provided for that purpose. In other words, the separation device 22 is preferably equipped with gravity removal means 31 and a recovery tank 33, which are intended to act in cooperation to remove said primary fraction 9 from said collector 19.

More advantageously, and as illustrated in FIG. 4, the distillation device 20 further comprises a means 36 for increasing the pressure inside said collector 19. Preferably, said pressure increasing means 36 is designed to implement said pressure increasing step.

Still more advantageously, and as illustrated in FIG. 4, said pressure increasing means 36 comprises a means for injecting vapour (for example, water steam) into said collector 19, said vapour injection means preferably comprising a gas injection tap arranged in a top part, more preferably an upper quarter, of said collector 19.

Preferably, and as illustrated in FIGS. 1, 2 and 5, said separation device 22 also comprises a circulation means 34 designed to extract said remaining fraction 10 from said separator 11 via said first outlet 15. In other words, said circulation means 34 advantageously allows removing said remaining fraction 10 from said separator 11, and that without carrying along in the same time said primary fraction 9, which, for its part, stays in said separator 11. Said circulation means 34 hence allows recovering the interesting fraction of the distillate 7, 7′ present in said separator 11 and separated into said primary 9 and remaining 10 phases, said interesting fraction being the remaining fraction 10, mainly formed of reusable hydrocarbons. Said remaining fraction 10 is then advantageously processed elsewhere in the refinery (for example, in a catalytic unit) or it may be reinjected into said column 1, 1′. Advantageously, said circulation means 34 is intended to implement said extraction step.

Advantageously, said circulation means 34 is designed to put in circulation semi-solid phases able to flow or to be pumped and/or fluids, said fluids being for example liquids (Newtonian or not), said fluids and/or semi-solid phase advantageously showing a viscosity close to that of petroleum products (for example, coming from so-called “opportunity” crudes) or that of hydrated precipitated chlorinated salts.

Preferably, said circulation means 34 is formed by a pump located downstream from said separator 11, for example a centrifugal pump.

Preferably, the distillation device comprises a fluidic connection line 37 between said separator 11 (and more particularly the first outlet 15) and said circulation means 34, for example a pipe.

Advantageously, and as illustrated in FIGS. 1, 2 and 5, said circulation means 34 ensures a continuous putting in circulation of the distillate 7, 7′ between said draw-off means 21 and said separator 11.

Preferably, and as illustrated in FIGS. 1, 2 and 5, said circulation means 34 also ensures a continuous extraction of said remaining fraction 10 from said separator 11, via said first outlet 15.

Advantageously, said column 1, 1′, said draw-off means 21, said separator 11 and said circulation means 34 belong to a circuit provided with means for establishing a permanent flow of fluid within said circuit, said fluid being formed by the distillate 7, 7′ between said draw-off means 21 and said inlet 14 of said separator 11, and by said remaining fraction 10 put in circulation out for said separator 11 via said first outlet 15.

Preferably, and as shown in FIGS. 1, 2 and 5, the distillation device 20 further comprises a means 23 for reintroducing said remaining fraction 10 into said column 1, 1′. Preferentially, said reintroduction means 23 is designed to implement said reintroduction step.

Advantageously, and as illustrated in FIGS. 1 and 2, said reintroduction means 23 comprises a reintroduction line 26, which corresponds for example itself to a pipe.

Advantageously, and as illustrated in FIGS. 1, 2 and 5, said reintroduction means 23 comprises an inlet tap 13, 13′ in said column 1, 1′.

Preferably, and as illustrated in FIGS. 1, 2 and 5, said inlet tap 13, 13′ is positioned at an altitude higher than that of said upper draw-off tray 6, 6′.

Preferably, and as illustrated in FIGS. 1, 2 and 5, said reintroduction line 26 allows ensuring the fluidic connection between said separator 11 and said column 1, 1′ via said first outlet 15 of said separator 11 and said inlet tap 13, 13′ of said column 1, 1′, respectively.

Advantageously, and as illustrated in FIGS. 1, 2 and 5, said circulation means 34 further ensures a continuous putting in circulation of the remaining fraction 10 between said separator 11 and said reintroduction means 23.

Preferably, said circulation means 34 is associated with, or grafted to, said reintroduction line 26. Indifferently, said reintroduction line 26 is fluidically connected to said connection line 37, or it is formed in part by said connection line 37. Advantageously, said reintroduction line 26 is in the form of a connection line 37 that would be extended up to the inlet tap 13, 13′ of the column 1, 1′, and with or to which said circulation means 34 would have been associated or grafted.

Advantageously, said pump forming said circulation means 34 is designed to continuously suck up said distillate 7, 7′ inside said separator 11 and said remaining fraction 10 from said separator 11, and to force back said remaining fraction into said column 1, 1′ via said inlet tap 13, 13′.

Preferably, said reintroduction means 23 is also a part of said circuit, said fluid being also formed by said remaining fraction 10 between the first outlet 15 of said separator 11 and said reintroduction means 23.

Preferably, and as illustrated in FIGS. 1, 2 and 5, said reintroduction means 23 comprises a cooling means 38 intended to reduce the temperature of said remaining fraction 10 before the reintroduction thereof into said column 1, 1′. Such a configuration allows advantageously controlling the temperature inside said column 1, 1′. More preferably, said cooling means 38 includes a heat exchanger, for example installed on said reintroduction means 26.

As an alternative, and as illustrated in FIGS. 1, 2 and 5, the distillation device 20 comprises a line 41 for the definitive discharge of said remaining fraction 10 intended to evacuate said remaining fraction 10, after the latter has been extracted from said separator 1, towards another unit (processing, storage or other) of the refinery, for example via a definitive discharge line 41. Optionally, the distillation device 20 comprises said definitive discharge line 41 and said reintroduction means 23, said remaining fraction 10 being then intended to be divided into two portions, one of which being sent back to said column 1, 1′ via said reintroduction means 23, and the other one being sent to said other unit via said definitive discharge line 41.

An example of implementation of the distillation method using the above-described distillation system 20 will now be exposed. According to this example, the distillation column 1, 1′ distillates, by heating them, petroleum products, which are formed by distilled hydrocarbons coming from an atmospheric distillation column, or by a crude, desalted or not. The distillation occurs at a temperature always higher than the dew point, but low enough so that chlorinated salts precipitate. Several intermediate distillates are collected by the draw-off trays of the column 1, 1′. The latter is provided with said upper draw-off tray 6, 6′ that itself collects a distillate 7, 7′ formed by condensation of the petroleum products at the column head 8, 8′. The distillate 7, 7′ includes hydrocarbons and a viscous deposit of precipitated chlorinated salts, these latter being at least partially hydrated by hygroscopicity. The distillate 7, 7′ of the upper draw-off tray 6, 6″ is continuously drawn off through an outlet tap 12 arranged in said column 1, 1′ at the same altitude or an altitude close to that of said upper draw off tray 6, 6′. The so drawn-off distillate 7, 7′ passes in the draw-off line 25 formed of a pipe, then enters the separator 11 via the inlet 14 of the latter. The draw off is facilitated or caused by a circulation means 34 as a pump that sucks up the distillate 7, 7′ from the column 1, 1′. Thereafter, the distillate 7, 7′ settles in the separator, so as to separate the primary fraction 9, comprising essentially the precipitated chlorinated salts, which flows in the bottom of the separator 11, and the remaining fraction 10, comprising essentially the hydrocarbons, which floats above the primary fraction 9 in said separator 11, the primary fraction 9 being wholly denser than the remaining fraction 10. The remaining fraction 10 is then extracted from the separator 11 through a first outlet 15 formed in the separator 11, by means of the circulation means 34. The remaining fraction 10 is then reintroduced into the column 1, 1′, above the upper draw-off tray 6, 6′ via an inlet tap 13, 13′ formed in the column 1, 1′. The primary fraction 9 is for its part concentrated in the funnel-shaped bottom 24 of the separator 11 and is then transferred by gravity in the collector 19 placed under the separator 11, via, successively, a second outlet 16 of the separator 11 and an inlet opening 27 of the collector 19. The circulation means 34 ensures the establishment of a continuous flow between the outlet tap 12, 12′ and the inlet tap 13, 13′ via the separator 11, in order to continuously capture the corrosive precipitated salts by gravity, with no complex mechanical element nor additional injection of water (in particular, in the hydrocarbons, to desalt them, for example), as they accumulate on the upper draw-off tray 6, 6′. Once the separator 11 sufficiently filled with the primary fraction 9, the inlet opening 27 is blocked with the first reversible blocking means 28, isolating the collector 19 from the separator 11. An outlet opening 29 of the collector 19 is then unblocked by the reversible blocking means 30, allowing the primary fraction 9 contained in said collector 19 to be poured by gravity from the latter. To facilitate and accelerate this last step, it is provided to increase the pressure in the collector 19 in order to push the primary fraction 9 out of the collector 19, and that by means of an injection of vapour into said collector 19. The primary fraction 9 that is poured from the collector 19 is then collected by a removal means of the flexible pipe type, where it is washed by injection of water, then transferred to a recovery tank 33 provided for that purpose. The second blocking means 30 is then closed back, whereas the first blocking means 28 is reopen, allowing the primary fraction 9 accumulated in the bottom of the separator 11 to be collected again by the collector 19. To sum up, the invention is based, schematically, on the idea to graft a salt trap on the draw-off circuit of a distillation column 1, 1′ in order to continuously remove said precipitated salts from the hydrocarbons. The so “purified” hydrocarbons can then be lead to a processing or storage unit, or be reintroduced into the distillation column, preferably downstream from the upper draw-off tray (i.e. above it). This continuous draw off of the precipitated salts allows limiting the risks of corrosion damages on the circuit to which the “salt trap” is connected.

Preferably, said draw-off means 21 and at least one part of said separation device 22 are made of a first material resisting to corrosion by said precipitated chlorinated salts, said first material being chosen among a group comprising titanium and the superalloys whose main components are, on the one hand, nickel, and on the other hand, chromium and/or copper. The superalloys advantageously include alloys having high mechanical or chemical resistance characteristics, in particular resistance to the phenomena of corrosion.

Still more preferably, said superalloy is chosen among a group comprising the alloys 400, such as Monel® 400, the alloys 625, such as Inconel® 625, and the alloys C-276, such as Hastelloy® C-276.

Preferably, said alloy 400 has for general formula NiₓCu_{y}Fe_{z}Mnₐ, x being higher than or equal to 63, y being comprised between 28 and 34 included, and z being lower than or equal to 2.5, a being lower than or equal to 2, other minority metals being possible; said alloy 625 has for general formula Ni_{b}Cr_{c}Mo_{d}FeₑNb_{f}, b being higher than or equal to 58, c being comprised between 20 and 23 included, d being comprised between 8 and 10 included, e being lower than or equal to 5, f being comprised between 3.15 and 4.15 included, other minority metals being possible; and said alloy C-276 has for general formula Ni_{g}CrₕMoᵢFeⱼWₖ, g being higher than or equal to 49, h being comprised between 14.5 and 16,5 included, i being comprised between 15 and 17 included, j being comprised between 4 and 7 included, and k being comprised between 3 and 4.5 included, other minority metals being possible.

More preferably, said first material is substantially more resistant to corrosion by said precipitated chlorinated salts than a second material of which is made said circulation means 34 and/or said reintroduction means 23. Hence, in order to show the better compromise possible between cost price and resistance, certain elements of the distillation device 20 are made of said first material, substantially more resistant, and hence generally more expensive, than other materials, substantially less resistant. Still more preferably, said draw-off line 25, said separator 11 and said collector 19 are made of said first material, because they are subjected to attacks, in particular acid attacks, by said precipitated chlorinated salts contained in said primary fraction 9, whereas said reintroduction means 23, and in particular said reintroduction line 26, is only subjected to the passage of said remaining fraction 10, which is preferably free from chlorinated salts, because these latter have been entrapped by the separator 11.

The invention also relates as such, according to a third aspect, to a device 22 for separating by gravity a petroleum product distillate 7, 7′, preferably designed to implement the separation step of the above-described petroleum product distillation method, within the above-described distillation device. The above description relating to the distillation method and the distillation device 20 hence also applies to the separation device 22.

According to the invention, the separation device 22 is designed to separate by gravity a petroleum product distillate 7, 7′ drawn off from a crude atmospheric distillation (CDU) column 1 or a vacuum distillation (VDU) column 1′ into, on the one hand, a primary fraction 9 including precipitated chlorinated salts and, on the other hand, a remaining fraction 10.

According to the invention, the separation device 22 comprises:
a gravity separator 11 intended to collect said distillate 7, 7′,
a collector 19 placed substantially under said separator 11 and in fluidic communication with the latter, said collector 19 being intended to collect said primary fraction by gravity.

Advantageously, said separator 11 and said collector 19 are made of a first material resisting to corrosion by said precipitated chlorinated salts, said first material being chosen among a group comprising titanium and the superalloys whose main components are, on the one hand, nickel, and on the other hand, chromium and/or copper.

Still more advantageously, said superalloy is chosen among a group comprising the alloys 400, such as Monel® 400, the alloys 625, such as Inconel® 625, and the alloys C-276, such as Hastelloy® C-276. Said alloys 400, 625 and C-276 have preferably the above-described formulas.

The invention also relates as such, according to a fourth aspect, a petroleum product atmospheric distillation (CDU) column 1 or vacuum distillation (VDU) column 1′, preferably designed to implement the distillation step of the above-described petroleum product distillation method, within the above-described distillation device 20, and in combination with the above-described separation device 22. The above description relating to the distillation method, to the distillation device 20 and to the separation device 22, hence also applies to the petroleum product atmospheric distillation (CDU) column 1 or vacuum distillation (VDU) column 1′.

According to the invention, the column 1, 1′ comprises a plurality of draw-off trays, including an upper draw-off tray 6, 6′, which is the draw-off tray the closest to the top 3, 3′ of said column 1, 1′, and at least one lower draw-off tray positioned at an altitude lower than that of said upper draw-off tray 6, 6′.

According to the invention, said upper draw-off tray 6′ of the atmospheric distillation (CDU) column 1 or vacuum distillation (VDU) column 1′ is made of a first material resisting to corrosion, in particular the corrosion by precipitated chlorinated salts. Said first material is advantageously adapted to resist to the phenomena of corrosion caused by the precipitated chlorinated salts preferably contained in said above-described primary fraction 69.

Within the framework of the invention, it has hence been discovered that it is particularly advantageous to adapt an atmospheric distillation (CDU) column 1 or a vacuum distillation (VDU) column 1′ to receive deposits of said precipitated chlorinated salts, by providing an upper draw-off tray 6, 6′, which is relatively resistant to the phenomena of corrosion induced by said chlorinated salts.

Such a configuration allows avoiding that said upper draw-off tray 6, 6′ is pierced due to phenomena of corrosion induced by the chlorinated salts contained in a distillate 7, 7′ collected by said upper draw-off tray 6, 6′, and hence implementing said column 1, 1′ within the above-described distillation device and in combination with the above-described separation device 22. In other words, this advantageous configuration of the upper draw-off tray 6, 6′ allows making it resistant enough over time to said chlorinated salts, so that it collects them before they are trapped out of the column 1, 1′ by means of a suitable device, advantageously the above-described separation device 22.

Such a configuration also allows advantageously avoiding that said upper draw-off tray 6, 6′, when pierced, lets said chlorinated salts flow onto the lower draw-off tray located below, risking to damage them by corrosion. Still more advantageously, the fact that said upper draw-off tray 6, 6′ collects the essential, or even the totality, of said chlorinated salts allows avoiding that these latter are accumulated on a lower draw-off tray or downstream from the latter, for example in a pipe of a refinery or a catalytic unit, seriously and relatively rapidly corroding the latter, causing in the worst case an extended stop of the production or a corporeal accident.

Preferably, the column 1, 1′ is intended to be implemented in combination with a salt trapping device out of the column 1, 1′, such as the above-described separation device 22 (or within the above-described distillation device 20), to evacuate said precipitated chlorinated salts (in particular contained in the above-described primary fraction 9), while ensuring a constant refining efficiency of the distillation unit of a refinery.

According to the invention, said first resistant material is chosen among a group comprising titanium and the superalloys whose main components are, on the one hand, nickel, and on the other hand, chromium and/or copper. The materials included in the above-mentioned group are particularly resistant to the phenomena of corrosion induced by said chlorinated salts, in particular the chlorinated salts contained in the above-described primary fraction 9.

Still more advantageously, said superalloy is chosen among a group comprising the alloys 400, such as Monel® 400, the alloys 625, such as Inconel® 625, and the alloys C-276, such as Hastelloy® C-276. The materials included in the above-mentioned group are particularly resistant to the phenomena of corrosion induced by said chlorinated salts, in particular the chlorinated salts contained in the above-described primary fraction 9. Said alloys 400, 625 and C-276 have preferably the above-described formulas.

Advantageously, said first material is substantially more resistant to the corrosion by said nitrogenous salts than a second material of which is made said lower draw-off tray. For example, said second material is stainless steel. In other words, said upper draw-off tray 6, 6′ is advantageously made of a first metal material particularly resistant to the corrosion of said chlorinated salts, whereas the lower draw-off tray located below, and the support elements thereof, may be made of materials not having a particular resistance to the precipitated chlorinated salts, as stainless steels. Such a configuration advantageously allows avoiding making said lower draw-off tray of said more resistant first material, in particular if the latter is more expensive than said second material.

The general principle of the present invention finally lies on the collection and evacuation, preferably in continuous mode, of salts formed in an atmospheric distillation (CDU) column or vacuum distillation (VDU) column. In normal mode of operation of the column during the distillation, the salts follow the same path as the hydrocarbons and are drawn off with the latter from the column. The general concept of the invention hence consists in subtracting the precipitated chlorinated salts from the flow of hydrocarbons by gravity settlement at the nearest of the column, so that the parts downstream from the column are no longer in contact with these salts.

The present invention offers a versatilesolution adaptable to all the distillation units of an existing refinery or a refinery to be built, and allows compensating for the limits of desalting efficiencies, without negatively impacting the capacity of production of the unit. It hence offers the opportunity to improve the efficiency and the production by processing a greater variety of marketed petroleums, without thereby being exposed to major risks of damage of the refinery components.

### POSSIBILITY OF INDUSTRIAL APPLICATION

The invention finds its industrial application in particular in the implementation of a petroleum product distillation method, as well as in the design, the manufacturing and the use of the corresponding material.

1-68. (canceled)

69. A petroleum product distillation method, comprising a step of distilling said products in a crude atmospheric distillation (CDU) or a vacuum distillation (VDU) column (1, 1′), wherein the column (1, 1′) itself comprises a plurality of draw-off trays, including an upper draw-off tray (6, 6′), which is the draw-off tray the closest to the top (3, 3′) of said column (1, 1′), the method further comprising a step of drawing off the distillate (7, 7′) present at said upper draw-off tray (6, 6′), and being characterized in that it also comprises a step of separating said so drawn-off distillate (7, 7′) into, on the one hand, a primary fraction (9) including precipitated chlorinated salts and, on the other hand, a remaining fraction (10).

70. The distillation method according to claim 69, characterized in that, during said distillation step, the temperature within said column (1, 1′) exceeds the dew point.

71. The distillation method according to claim 69, characterized in that said primary fraction (9) is predominantly formed in weight of said precipitated chlorinated salts, preferably at more than 80% by weight.

72. The distillation method according to claim 69, characterized in that at least one portion of said precipitated chlorinated salts is hydrated and in that said precipitated chlorinated salts are predominantly precipitated ammonium and/or amine salts, preferably at more than 80% by weight.

73. The distillation method according to claim 72, characterized in that said ammonium salts are ammonium chloride salts.

74. The distillation method according to claim 69, characterized in that said separation step is performed by means of a gravity separator (11) and in that, during said separation step, said primary fraction (9), which is denser than said remaining fraction (10), is separated by gravity from the remaining fraction (10), and in that it comprises:
previously to said separation step, a step of introducing said distillate (7, 7′) into said separator (11) via an inlet (14) of said separator (11), and
subsequently to said separation step, an extraction step during which said remaining fraction (10) is extracted at least partially from said separator (11) via a first outlet (15) of said separator (11).

75. The distillation method according to claim 74, characterized in that it comprises, subsequently to said separation step, a first step of evacuating by gravity said primary fraction (9) from said separator (11) via a second outlet (16) of said separator (11), and in that, during said first evacuation step, said primary fraction (9) is evacuated by gravity in a collector (19) placed substantially under said separator (11) and in fluidic communication with the latter.

76. The distillation method according to claim 75, characterized in that it further comprises a second step of evacuating by gravity said primary fraction (9) from said collector (19).

77. The distillation method according to claim 75, characterized in that it further comprises an isolation step, in which said collector (19) is isolated from said separator (11).

78. The distillation method according to claim 75, characterized in that it further comprises a step of increasing the pressure inside said collector (19).

79. The distillation method according to claim 78, characterized in that said pressure increasing step is made by injection of vapour into said collector (19).

80. The distillation method according to claim 69, characterized in that it further comprises a step of reintroducing said remaining fraction (10) into said column (1, 1′).

81. The distillation method according to claim 80, characterized in that the reintroduction of said remaining fraction (10) into said column (1, 1′) is made via an inlet tap (13, 13′) into said column (1, 1′) at an altitude higher than that of said upper draw-off tray (6, 6′).

82. A petroleum product distillation device (20) comprising a crude atmospheric distillation (CDU) or vacuum distillation (VDU) column (1, 1′), column (1, 1′) in which the temperature exceeds the dew point, wherein said column (1, 1′) itself comprises a plurality of draw-off trays, including an upper draw-off tray (6, 6′), which is the draw-off tray the closest to the top (3, 3′) of said column (1, 1′), and a means (21) for drawing off the distillate (7, 7′) present at said upper draw-off tray (6, 6′), characterized in that it also comprises a device (22) for separating the so drawn-off distillate (7, 7′) into, on the one hand, a primary fraction (9) including precipitated chlorinated salts and, on the other hand, a remaining fraction (10).

83. The distillation device (20) according to claim 82, characterized in that said separation device (22) comprises a gravity separator (11) intended to collect said distillate (7, 7′), and in that said separator (11) comprises:
an inlet (14) intended to introduce said distillate (7, 7′) into said separator (11),
a first outlet (15) intended to extract said remaining fraction (10) from said separator (11), and
a second outlet (16) intended to evacuate said primary fraction (9) from said separator (11), and which is distinct from said first outlet (15).

84. The distillation device (20) according to claim 83, characterized in that said separation device (22) further comprises a collector (19) placed substantially under said separator (11) and in fluidic communication with the latter, said collector (19) being intended to collect said primary fraction (9) by gravity, said collector (19) further comprising an inlet opening (27) for the entry of said primary fraction (9) that fluidically corresponds with said second outlet (16),the distillation device (20) comprising a first means (28) for the reversible blocking of said inlet opening (27) and/or of said second outlet (16).

85. The distillation device (20) according to claim 84, characterized in that said collector (19) further comprises an outlet opening (29) for the exit of said primary fraction (9), located at an altitude lower than that of said inlet opening (27), and second means (30) for the reversible blocking of said outlet opening (29).

86. The petroleum product distillation device (20) according to claim 82, characterized in that said draw-off means (21) and at least one part of said separation device (22) are made of a first material resisting to corrosion by said precipitated chlorinated salts, said first material being chosen among a group comprising titanium and the superalloys whose main components are, on the one hand, nickel, and on the other hand, chromium and/or copper.

87. The petroleum product distillation device (20) according to claim 86, characterized in that said superalloy is chosen among a group comprising the alloys 400, the alloys 625 and the alloys C-276.

88. A device (22) for separating by gravity a petroleum product distillate (7, 7′) drawn off from a crude atmospheric distillation (CDU) or vacuum distillation (VDU) column (1, 1′) into, on the one hand, a primary fraction (9) including precipitated chlorinated salts and, on the other hand, a remaining fraction (10), the separation device (22) comprising:
a gravity separator (11) intended to collect said distillate (7, 7′), and
a collector (19) placed substantially under said separator (11) and in fluidic communication with the latter, said collector (19) being intended to collect said primary fraction (9) by gravity.
